(19) United States
(12) Patent Application Publication
(10) Pub. No.: US 2020/0323058 A1
(43) Pub. Date: Oct. 8, 2020

(54) LIGHTING SYSTEM

(71) Applicant: ARTEMIDE S.p.A., Milano (IT)

(72) Inventors: Carlotta Francesca Isolina Maria DE BEVILACQUA, Milano (IT); Fabio ZANOLA, Missaglia (LC) (IT)

(21) Appl. No.: 16/838,731

(22) Filed: Apr. 2, 2020

(30) Foreign Application Priority Data
Apr. 5, 2019 (IT) 102019000005230

(51) Int. Cl. H05B 45/12; H05B 45/22; H05B 47/19

(52) U.S. Cl. CPC H05B 45/12; H05B 47/19; H05B 45/22

(57) ABSTRACT

A lighting system for lighting a target comprises at least one lighting apparatus having at least one LED light source capable of varying colour temperature and light intensity of the emitted light; a sensor configured so as to detect colour temperature and light intensity of the light that hits the sensor and to provide signals representative of the detected colour temperature and light intensity; and a control unit connected to the lighting apparatus and the sensor for adjusting colour temperature and light intensity of the light emitted by the lighting apparatus depending on signals received from the sensor.

### CROSS-REFERENCE TO RELATED APPLICATIONS

This Patent Application claims priority from Italian Patent Application No. 102019000005230 filed on Apr. 5, 2019, the entire disclosure of which is incorporated herein by reference.

### TECHNICAL FIELD

This invention relates to a lighting system.

In particular, the invention relates to a system for lighting specific targets (selected objects or areas), e.g. for lighting exhibits such as works of art displayed in a museum or gallery.

### BACKGROUND ART

In general, to illuminate a specific exhibit in a room, one or more lighting apparatuses are used to emit light towards the object, directly and/or in the room. The lighting of the object is affected by environmental conditions and is therefore influenced not only by the artificial light emitted by the apparatuses placed in the room in order to light the object, but also by the light emitted by other apparatuses that may be present and by natural light, which enters the room through windows, for example. The lighting of the object therefore changes, in intensity and colour spectrum, as the lighting conditions of the room in which the object is located vary.

The object may therefore appear differently in the eyes of observers as lighting conditions vary.

There are known lighting control systems, including in the museum sector, based on the use of sensors connected to the lamps that light the works on display.

In the known systems, sensors detect ambient light or light directly emitted by the lamps. Based on the values detected by the sensors, a control system modifies the lamps' output to restore pre-set lighting conditions.

This type of system is not completely satisfactory, especially because it does not ensure that the lit subject will always maintain the desired lighting when the ambient lighting conditions vary.

### DISCLOSURE OF INVENTION

One purpose of this invention is to provide a lighting system, in particular for lighting specific targets, that is free of the drawbacks highlighted herein of the prior art; in particular, one purpose of this invention is to provide a lighting system that enables the lighting of the target to be accurately and precisely controlled even when the lighting conditions in the surrounding environment vary.

Thus, this invention relates to a lighting system, in particular for lighting specific targets, as defined in basic terms in the appended claim 1 and, in the additional features thereof, in the dependent claims.

In accordance with the invention, the lighting system is associated with a sensor that is placed in the immediate vicinity of the target, i.e. the object that all the lighting apparatuses, which implement the desired lighting solution for the target, highlight (not necessarily directly, but also peripherally).

The sensor is a qualitative and quantitative sensor, configured so as to detect both the light intensity and the colour temperature of the light hitting it.

In this way, the lighting system of the invention makes it possible to keep the lighting conditions of the target constant, both in quantitative terms (lighting) and in terms of colour temperature when the environmental conditions vary.

The lighting system of the invention makes it possible, in addition, to extremely precisely adjust the lighting conditions of the target.

In fact, the lighting system of the invention detects the light conditions in strict proximity to the target, i.e. right where it is important to ensure the pre-set lighting features.

The lighting system of the invention is, then, particularly easy and practical to manufacture, install, and use.

In fact, the sensor is placed near the target, leaving, instead, the target lighting apparatus or apparatuses in the most convenient positions. The sensor communicates data wirelessly.

### BRIEF DESCRIPTION OF THE DRAWINGS

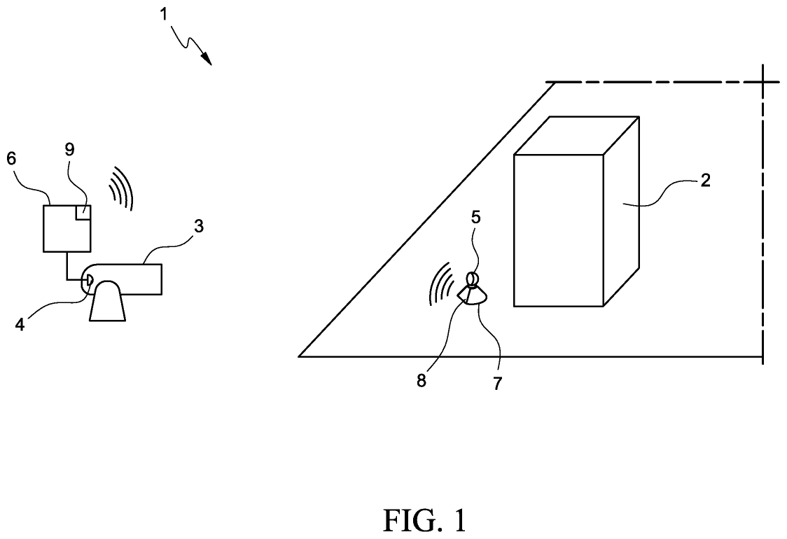

Additional features and advantages of this invention will become clear from the following description of a non-limiting embodiment thereof, with reference to FIG. 1 attached hereto that shows a schematic view of a lighting system in accordance with the invention.

### BEST MODE FOR CARRYING OUT THE INVENTION

In the attached drawing, the reference number 1 indicates, as a whole, a lighting system, used, in particular, for lighting a target 2, for example an exhibit. It is understood that the system of the invention can be used in other applications, not just for lighting objects and works of art exhibited in a museum or gallery, but also items exhibited in commercial businesses or other contexts.

The lighting system 1 comprises: at least one lighting apparatus 3 having at least one LED light source 4 capable of varying colour temperature and light intensity of the emitted light; a sensor 5 capable of detecting light parameters; and a control unit 6 connected to the lighting apparatus 3 and to the sensor 5 for controlling the output of the lighting apparatus 3 and, specifically, of the light source 4 depending on the signals received from the sensor 5.

The lighting system 1 may also comprise more lighting apparatuses 3, possibly grouped in sets.

In general, each lighting apparatus 3 is equipped with an LED light source 4 (comprising one or more LEDs) defining an LED system with adjustable output, which is capable, in particular, of adjusting the colour temperature and the light intensity of the emitted light.

In general, the lighting system 1 comprises one or more lighting apparatuses 3 capable of emitting white light with adjustable colour temperature (so-called Tunable-White apparatuses).

The sensor 5 is configured so as to detect the colour temperature and light intensity of the light that hits the sensor 5 and to provide signals that represent the colour temperature and the light intensity of the incident light radiation.

For example, the sensor 5 is provided with at least one RGB-type sensitive element, capable of providing three RGB values that represent the colour of the incident light radiation and to extrapolate from said three RGB values a colour temperature value of the incident light radiation; in addition, the sensor 5 is also capable of detecting the light intensity (via the same RGB-type sensitive element, or a second, specific sensitive element for light intensity).

The sensor 5 is supported by a support body 7 that is a distinct and separate body with respect to the lighting apparatus 3, so as to be placed in proximity to the target 2 to be lighted using the lighting system 1 and, thus, in a remote position with respect to the lighting apparatus 3.

The sensor 5 is provided with a wireless transmitter 8 and is connected in wireless mode to the control unit 6, which is equipped with a wireless receiver 9.

The control unit 6 can be integrated into the lighting apparatus 3 or be arranged remotely in relation to the lighting apparatus 3.

In any case, the control unit 6 is connected to the light source 4 of the lighting apparatus 3 and to the sensor 5 to control the lighting apparatus 3, by adjusting the light intensity and the colour temperature of the light emitted by the lighting apparatus 3, depending on the signals received from the sensor 5.

The control unit 6 is equipped with an algorithm for managing the lighting system 1.

It is, however, also possible to use a plurality of sensors 5, connected to corresponding control units 6 or to a single control unit 6; for example, it is possible to provide a sensor-control unit pair for each set or group of lighting apparatuses 3 that need to be adjusted.

The operation of the lighting system 1 for lighting the target 2 is as follows.

The lighting apparatus 3 is installed in the environment (for example, in the room) in which the target 2 to be lighted is located, so that the light emitted by the lighting apparatus 3 at least partially lights the target 2.

The sensor 5 is placed near the target, so that it receives light from the lighting apparatus 3 basically in the same way as the target 2 or at least part of the target. It can, therefore, be assumed that the light that the sensor 5 receives from the lighting apparatus 3 has basically the same colour temperature and intensity as the light that reaches the target 2, or at least at a part of the target 2, near the sensor.

In a typical use situation for the lighting system 1, the target 2 is located in a room wherein the lighting conditions are not only determined by the lighting apparatus 3 (or by the lighting apparatuses 3, if more than one) of the lighting system 1, but are affected by the natural light that enters the room and/or by the artificial light coming from other sources beyond the lighting system 1.

The target 2 is, thus, lit by the combination of light coming from the lighting system 1 and light coming from other sources, natural and/or artificial, which, together, determine the ambient light; the ambient light is, thus, given by the natural light in the room in which the target 2 is located and any light coming from other artificial light sources present in the same room.

During calibration, the optimal conditions of colour temperature and light intensity that you want on the target 2 are determined.

The control unit 6 is, therefore, initially calibrated so that the lighting system provides the light required in order to have the pre-set values of colour temperature and light intensity on the target 2 (and on the sensor 5).

The sensor 5 then detects colour temperature and light intensity over time: when the environmental conditions vary, basically owing to changes in ambient light, the sensor 5 transmits colour temperature and light intensity data, other than those pre-set, to the control unit 6.

The control unit 6 compares the data transmitted by the sensor 5 with the reference values pre-set and, in case of deviations, controls, as a result, the lighting apparatus 3 in order to restore the lighting conditions pre-set for the target 2.

More specifically, the sensor 5 sends signals representing the colour temperature and light intensity detected by the sensor 5 near the target 2, and which can thus be assumed to be representative of the light conditions on the target 2 (or at least on a part thereof near the sensor 5), to the control unit 6.

The control unit 6 processes the signals received from the sensor 5 and calculates the deviations of each parameter detected in relation to a reference condition.

If there are deviations in relation to the reference condition, the control unit 6 calculates which variations in the lighting apparatus 3 operating parameters are necessary in order to restore the reference condition and control, as a result, the operation of the lighting apparatus 3, specifically of the light source 4, so that the lighting apparatus 3 provides a colour temperature and light intensity that will restore the reference condition.

Lastly, it is understood that the lighting system as described and illustrated herein can be subject to additional modifications and variations that do not depart from the scope of the accompanying claims.

1. A lighting system (1) for lighting a target (2), comprising at least one lighting apparatus (3) having at least one LED light source (4) capable of varying colour temperature and light intensity of the emitted light; a sensor (5) configured so as to detect colour temperature and light intensity of the light that hits the sensor (5) and to provide signals representative of the detected colour temperature and light intensity; and a control unit (6) connected to the lighting apparatus (3) and the sensor (5) for adjusting colour temperature and light intensity of the light emitted by the lighting apparatus (3) depending on signals received from the sensor (5).

2. A lighting system according to claim 1, wherein the sensor (5) is supported by a support body (7) that is a distinct and separate body with respect to the lighting apparatus (3), so as to be placed in use in proximity to the target (2) to be lighted by the lighting system (1) and in a remote position with respect to the lighting apparatus (3).

3. A lighting system according to claim 1, wherein the sensor (5) is provided with a wireless transmitter (8) and is connected in wireless mode to the control unit (6).

4. A lighting system according to claim 1, wherein the control unit (6) has a memory storing at least one reference condition identified by pre-set values of colour temperature and light intensity; and wherein the control unit (6) is configured so as to: process signals received from the sensor (5) and representative of current values of colour temperature and light intensity detected by the sensor (5); calculate deviations between the values of colour temperature and light intensity detected by the sensor (5) and the pre-set values of colour temperature and light intensity of the reference condition; calculate variations of operating parameters of the lighting apparatus (3) required to restore the reference condition; control the operation of the lighting apparatus (3) and, specifically, of the light source (4) so as to provide colour temperature and light intensity such as to restore the reference condition.
